(19) United States
(12) Patent Application Publication
(10) Pub. No.: US 2022/0194831 A1
(43) Pub. Date: Jun. 23, 2022

(54) System and Method for Treating Wastewater That Includes Biosorption and Filtration

(71) Applicants: Argun ERDOGAN, Cary, NC (US); Veolia Water Solutions & Technologies Support, Saint-Maurice (FR)

(72) Inventor: Argun O. Erdogan, Cary, NC (US)

(21) Appl. No.: 17/598,973

(22) PCT Filed: Mar. 27, 2020
(86) PCT No.: PCT/US2020/025176

§ 371 Date: Sep. 28, 2021

Related U.S. Application Data
(60) Provisional application No. 62/827,985, filed on Apr. 2, 2019.

(51) Int. Cl. C02F 3/12; C02F 3/08; C02F 1/00; C02F 11/126; C02F 11/125

(52) U.S. Cl. CPC C02F 3/121; C02F 3/1215; C02F 3/085; C02F 11/125; C02F 1/004; C02F 11/126; C02F 3/1221

(57) ABSTRACT

The present invention relates to an efficient and cost effective wastewater treatment process that aims to reduce the concentration of soluble and colloidal and particular organic material upstream of a biological treatment process. In particular, the wastewater treatment process described includes a pre-treatment process that relies on biosorption and filtration to reduce the concentration of soluble and insoluble organic matter.

### FIELD OF THE INVENTION

The present invention relates to wastewater treatment processes and more particularly to wastewater treatment processes having pre-treatment units designed to reduce soluble and colloidal and particulate organic matter in the wastewater.

### BACKGROUND OF THE INVENTION

In some biological wastewater treatment processes, excessive carbon in the wastewater is problematic. For example, the presence of excessive carbon in a deammonification process is concerning. Moreover, in a deammonification process, the presence of substantial soluble and colloidal and particulate organic material can give rise to nitrite oxidizing bacteria (NOB) that compete with bacteria relied upon to remove ammonium (NH₄—N). Hence, in these situations, the efficient removal of both soluble and colloidal and particulate organic matter will improve processes such as deammonification processes.

### SUMMARY OF THE INVENTION

The present invention is an efficient and cost effective wastewater treatment method that aims to reduce the concentration of soluble and colloidal and particulate organic material upstream of a biological treatment process. In particular, the wastewater treatment process described herein includes a pre-treatment process that relies on biosorption and filtration to reduce the concentration of soluble and insoluble organic matter.

In one embodiment, the wastewater being treated is directed to a biosorption reactor. There, waste activated sludge is mixed with the wastewater under aerobic conditions. Active bacteria in the activated sludge take up soluble organics while colloidal and particulate organic matter is adsorbed onto the waste activated sludge. After treatment in the biosorption reactor, the wastewater and waste activated sludge is directed to a filtration unit that removes a substantial portion of the waste activated sludge. Removed waste activated sludge is discharged from the filtration unit. In one embodiment, the filtration unit includes a disc and/or drum filter that removes the waste activated sludge. Downstream of the filtration unit is a biological reactor or treatment unit that biologically treats the wastewater.

The method described above can be carried out in a main stream or a side stream. Further, in one embodiment, the biological treatment that occurs downstream of biosorption and filtration is a deammonification process that removes ammonium from the wastewater.

Other objects and advantages of the present invention will become apparent and obvious from a study of the following description and the accompanying drawings which are merely illustrative of such invention.

### BRIEF DESCRIPTION OF THE DRAWINGS

FIG. 1 is a diagrammatic view of a wastewater treatment process according to the present invention.

FIG. 2 is a diagrammatic view of an alternative wastewater treatment process according to the present invention.

### DESCRIPTION OF EXEMPLARY EMBODIMENTS

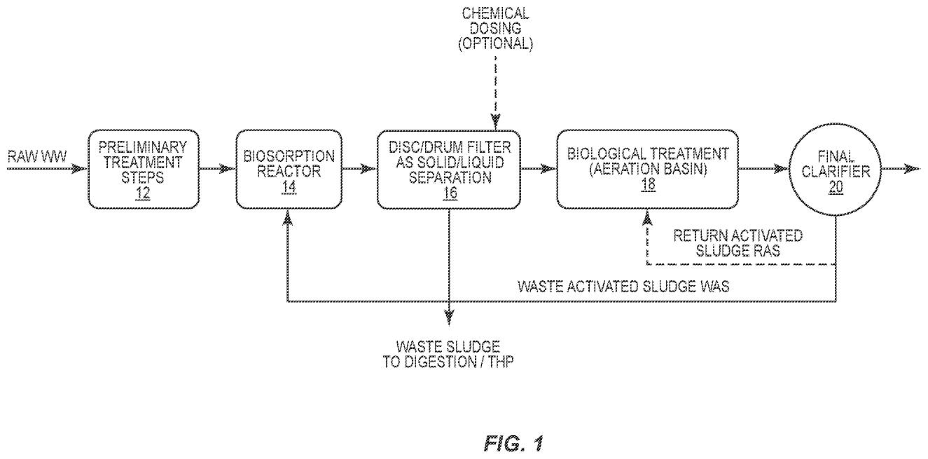

With further reference to the drawings, particularly FIG. 1, a wastewater treatment system and process is shown therein and indicated generally by the numeral 10. First, the components or elements of the system will be described. Wastewater to be treated is directed to a preliminary treatment system 12 that functions to provide preliminary treatment for the wastewater influent. Various types of preliminary treatments can be carried out in the preliminary treatment system 12. For example, in some cases, it may be beneficial to provide a primary clarifier for clarifying the wastewater influent. However, it should be appreciated that there are numerous other preliminary treatments that can be employed.

Downstream of the preliminary treatment system 12 is a biosorption reactor 14. As will be discussed in more detail below, the biosorption reactor 14 functions to remove soluble and insoluble organic matter from the wastewater. Effluent from the biosorption reactor 14 is directed to a filtration unit 16. Various types of filtration systems can be employed in the filtration unit 16. In one embodiment, the filtration unit 16 includes a disc filter or a drum filter. As discussed below, the filtration unit 16 functions to remove solids, particularly waste activated sludge, from the wastewater.

Downstream of the filtration unit 16 is a biological reactor or treatment unit 18. This reactor or treatment unit can take various forms and perform various biological treatments. As discussed below, in some embodiments the biological treatment unit 18 is designed to remove ammonium from the wastewater.

A final clarifier 20 is disposed downstream of the biological treatment unit 18. Final clarifier 20 receives effluent from the biological treatment unit 18 and produces a clarified effluent and at the same time produces activated sludge that it returned to the biological treatment unit 18 as return activated sludge. See FIG. 1. In addition, a portion of the activated sludge produced by the clarifier 20 is deemed waste activated sludge (WAS). In the embodiment illustrated in FIG. 1, this waste activated sludge is directed to the biosorption reactor 14 and mixed with the wastewater therein.

Now the method or process shown in FIG. 1 will be described. Raw wastewater directed into the preliminary treatment unit 12 can contain a range of contaminants. For example, the wastewater can contain suspended solids, soluble and, colloidal and particulate organic matter (carbon), ammonium and other contaminants. After the wastewater has been subjected to preliminary treatment in preliminary treatment unit 12, the effluent therefrom is directed into the biosorption reactor 14. Waste activated sludge from the final clarifier 20 or from another source is mixed with the wastewater under aerobic conditions. The degree of aeration can vary but in one embodiment, the biosorption reactor is operated under slightly aerobic conditions. Hydraulic retention time in the biosorption reactor 14 can vary. However, in one embodiment, it is contemplated that the hydraulic retention time is approximately 15-30 minutes.

In the biosorption reactor 14, active bacteria in the waste activated sludge takes up and stores a majority of the soluble organics within the cell walls of the bacteria. Colloidal and particulate organic matter is generally adsorbed onto the waste activated sludge. Thus, in the biosorption reactor 14, a majority of the organic matter in the wastewater is removed.

Effluent from the biosorption reactor 14 is directed to a filtration unit 16. Here the waste activated sludge is separated and removed from the wastewater. The separated waste activated sludge and other solids removed can be sent to an anaerobic digester or a thermal hydrolysis unit for further processing.

Various types of solids—liquid separators can be employed in the filtration unit 16. In a preferred embodiment, the filtration unit 16 includes a disc filter or a drum filter. Details of the disc filter and drum filter are not shown. For a complete and unified understanding of both disc filters and drum filters, one is referred to U.S. Pat. No. 9,962,635 (the '635 patent) and U.S. Pat. No. 7,972,508 (the '508 patent). The disclosures of the '635 and '508 patents are expressly incorporated by reference.

In the case of a disc filter, effluent from the biosorption reactor 14 is directed into a series of discs disposed on a drum. Each disc includes filter media on opposite sides thereof. Effluent from the biosorption reactor 14 is filtered by the filtered media. Waste activated sludge in the effluent is captured by the filter media. By a backwashing process, the waste activated sludge and other solids are removed from the filter media and discharged from the disc filter. The wastewater with depleted organic matter flows through the filter media and is directed to the biological treatment unit 18.

A drum filter, on the other hand, differs from the disc filter discussed above in that the filter media is placed on a drum of the drum filter. Wastewater and waste activated sludge is directed into the drum of the drum filter. The drum includes panels of filter media secured around the drum. Like the disc filter, the drum filter includes a backwashing system that, as applied in the present invention, backwashs the filter media and removes the waste activated sludge and other solids therefrom, after which the separated waste activated sludge and other solids can be discharged from the drum filter.

Effluent from the filtration unit 16 is depleted in organic matter and waste activated sludge. This effluent is directed into the biological treatment unit 18 where the wastewater is biologically treated. Various types of biological treatment can be performed in the biological treatment unit 18. In one embodiment, the biological treatment unit is designed to perform a deammonification process to remove ammonium from the wastewater. Details of the deammonification process are not dealt with herein. See, for example, U.S. Pat. No. 8,864,993 (the '993 patent) which describes a deammonification process. The disclosure of the '993 patent is expressly incorporated herein.

Many wastewater streams (main streams or side streams) include a high concentration of ammonium. By employing certain bacteria, ammonium can be removed from the wastewater by a conventional nitrification/denitrification process. Ammonium can also be removed through what is termed a deammonification process which employs bacteria different from the bacteria employed in a conventional nitrification/denitrification process. In a deammonification process, the process combines aerobic nitritation and anaerobic ammonium oxidation (ANAMMOX). In the nitritation step, aerobic oxidizing bacteria (AOB) oxidizes a substantial portion of the ammonium in the waste stream to nitrite (NO₂). Then in the second step, the ANAMMOX bacteria converts the remaining ammonium and the nitrite to nitrogen gas (N₂) and in some cases a small amount of nitrate (NO₃). Again this total process, i.e. nitritation and the ANAMMOX process is referred to as deammonification.

Effluent from the biological treatment unit 18 is directed to the final clarifier 20. As noted above, the final clarifier 20 produces a treated effluent and return activated sludge. The return activated sludge is recycled to the biological treatment unit 18. A portion of the activated sludge produced by the final clarifier 20 is denoted waste activated sludge. In the process shown in FIG. 1, the waste activated sludge is directed upstream and mixed with the wastewater in the biosorption reactor 14. A substantial portion of the waste activated sludge is removed by the filtration unit 16.

The method shown in FIG. 1 and described above may be a main stream process or a side stream process. In either case, the combined pre-treatment process of the biosorption reactor 14 in the filtration unit 16 removes a substantial portion of the soluble and insoluble organic matter from the wastewater. This typically reduces excessive carbon in the wastewater and in the case of a deammonification process, facilitates the effectiveness of the deammonification process in removing ammonium from the wastewater.

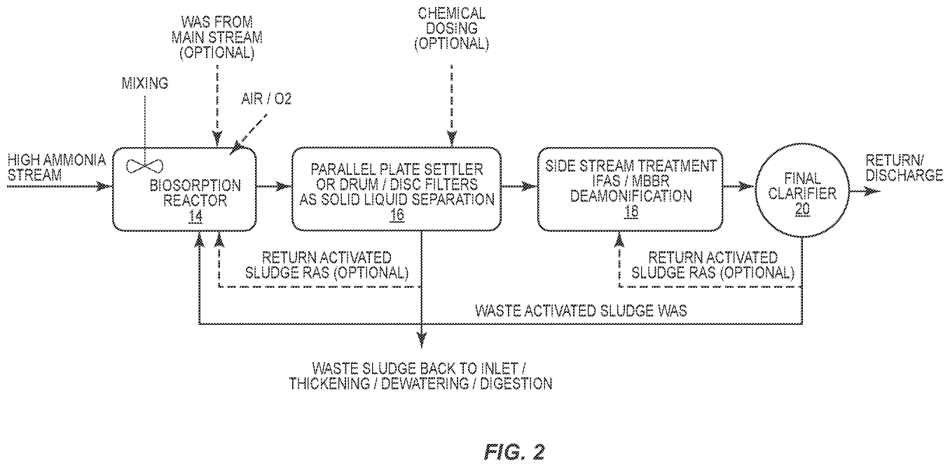

Turning to FIG. 2, a second wastewater treatment process is shown. Again, the process depicted here can be either a main stream process or a side stream process. The process shown in FIG. 2 is particularly useful in removing ammonium from a wastewater stream and particularly amenable to a side stream deammonification process.

Continuing to refer to FIG. 2, a wastewater stream high in ammonium is directed into the biosorption reactor 14. By high ammonium concentration, it meant that the wastewater influent has an ammonium (NH₄—N) concentration of approximately 500 mg/L or higher. As discussed, waste activated sludge is mixed with the wastewater in the biosorption reactor 14. There can be various sources for the waste activated sludge. As described with respect to FIG. 1, the waste activated sludge can be produced by the final clarifier 20. In some cases, waste activated sludge from an external source is directed into the biosorption reactor 14. In a case where the process shown in FIG. 2 is a side stream process, it is appreciated that waste activated sludge from the main stream process can be directed into the biosorption reactor 14. In some cases, both waste activated sludge from an external source and from the final clarifier 20 can be used to drive the biosorption reactor 14.

Effluent from the biosorption reactor 14 is again directed to a filtration unit 16. The preferred filtration unit 16 again comprises a disc filter or a drum filter. But it is understood and appreciated by those skilled in the art that other solids-liquid separation devices, such as a parallel plate settler, can be employed.

Effluent from the filtration unit 16 is directed to the biological treatment unit or system 18. In the embodiment shown in FIG. 2, the biological treatment system 18 is designed to perform a deammonification process by employing an integrated fixed film activated sludge (IFAS) process or a moving bed bioreactor (MBBR) process. One is again referred to the disclosures in the '993 patent and Appendix A for an understanding of typical deammonification processes. As discussed above, the effluent from the biological treatment system 18 is directed to the final clarifier 20 which again produces a clarified effluent and return activated sludge that, as an option, can be returned to the biological treatment system 18 to support a deammonification process therein.

One of the challenges in operating a deammonification process is to minimize the presence of nitrite oxidizing bacteria (NOB) in the deammonification process. This is because the deammonification process depends on anaerobic ammonium oxidizing (ANAMMOX) bacteria. ANAMMOX bacteria rely on nitrite for the removal of ammonium. Nitrite oxidizing bacteria converts nitrite to nitrate. If substantial nitrite oxidizing bacteria is permitted to enter the deammonification process, they will compete with the ANAMMOX bacteria for nitrite and this will limit the denitrification process. Thus, in the case of the present invention, steps are taken to prevent an overabundance of nitrite oxidizing bacteria in the deammonification process. As illustrated in FIGS. 1 and 2, an option exists for using chemical dosing in the filtration unit 16. Chemical dosing with a coagulant and/or a flocculant will increase the filtration efficiency of the filtration unit 16. By increasing the filtration efficiency, this means that less biomass that includes nitrite oxidizing bacteria is allowed to pass from the filtration unit 16 to the biological treatment unit 18 where deammonification can be practiced.

There are numerous advantages of the processes shown in FIGS. 1 and 2. By pre-treating the wastewater with the biosorption reactor 14 and the filtration unit 16, excess carbon-to-nitrogen ratios are avoided since soluble and insoluble organic matter is removed via the waste activated sludge, which is ultimately discharged from the wastewater stream by the filtration unit 16.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of treating wastewater containing soluble and colloidal and particulate organic material comprising:
directing the wastewater to a biosorption reactor;
directing the wastewater from the biosorption reactor to a disc or drum filter;
directing the wastewater from the disc or drum filter to an integrated fixed film activated sludge (IFAS) reactor or to a moving bed bioreactor (MBBR) and subjecting the wastewater to a deammonification process in the IFAS reactor or the MBBR;
directing an effluent from the IFAS reactor or the MBBR to a clarifier and producing a clarified effluent and an activated sludge containing active bacteria;
directing a portion of the activated sludge to the biosorption reactor and mixing the activated sludge with the wastewater therein;
operating the biosorption reactor under aerobic conditions;
removing at least a portion of the soluble organic material in the wastewater via the active bacteria in the activated sludge directed to the biosorption reaction;
adsorbing the colloidal and particulate organic matter in the wastewater onto the activated sludge in the biosorption reactor;
removing the activated sludge directed to the biosorption reactor with the disc filter or drum filter; and
wasting at least a portion of the activated sludge removed by the disc filter or drum filter.

2. The method of claim 1 including limiting the hydraulic retention time of the wastewater in the biosorption reactor to approximately 15 to approximately 30 minutes.

3. The method of claim 1 including directing at least a portion of the waste activated sludge from the disc filter or drum filter to an anaerobic digester or a thermal hydrolysis unit.

4. The method of claim 1 including limiting the amount of biomass containing nitrite oxidizing bacteria passing from the disc filter or drum filter to the deammonification process by directing a coagulant or a flocculant into the drum filter or disc filter and mixing the coagulant or the flocculant with the wastewater in the disc filter or drum filter.

5. A method of treating wastewater containing soluble and colloidal and particulate organic material, the method comprising:
subjecting the wastewater to a biosorption process by mixing waste activated sludge with the wastewater in a biosorption reactor under aerobic conditions wherein active bacteria in the waste activated sludge removes the soluble organics from the wastewater while the colloidal and particulate carbon are adsorbed onto the waste activated sludge;
downstream of the biosorption reactor, subjecting the wastewater and waste activated sludge to a filtration process and removing a substantial portion of the waste activated sludge from the wastewater;
after removing the waste activated sludge from the wastewater, biologically treating the wastewater by directing the wastewater to a biological treatment unit and mixing activated sludge with the wastewater;
directing an effluent from the biological treatment reactor to a clarifier and producing a clarified effluent and the activated sludge which is recycled to the biological treatment unit; and
wherein a portion of the activated sludge is wasted which produces the waste activated sludge directed to the biosorption reactor.

6. The method of claim 5 wherein the wastewater includes ammonia and wherein the method includes removing ammonia from the wastewater through a deammonification process carried out, in part at least, in the biological treatment reactor.

7. The method of claim 5 wherein the method is performed in a main stream or side stream.
